(19) United States
(12) Patent Application Publication
(10) Pub. No.: US 2003/0157247 A1
(43) Pub. Date: Aug. 21, 2003

(54) Method for producing coated bioactive granule

(76) Inventors: Yoshiro Chikami, Kumamoto (JP); Narutoshi Kimoto, Kumamoto (JP); Atsushi Takahashi, Kumamoto (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/311,268

(22) PCT Filed: Jun. 13, 2001
(86) PCT No.: PCT/JP01/05038

(30) Foreign Application Priority Data
Jun. 14, 2000 (JP) 2000-178119
Jun. 14, 2000 (JP) 2000-178120

(51) Int. Cl. B05D 7/00

(52) U.S. Cl. 427/212

(57) ABSTRACT

A method for producing a coated bioactive granule comprising a core granule containing a bioactive substance and a coating film covering the surface of the core, characterized by comprising a step of reducing the concentration of a volatile matters contained in the bioactive substance; and a method for producing the coated bioactive granule wherein the production conditions are controlled in a manner such that physical properties and/or functions of a coated bioactive granule produced (hereinafter referred to as “product data”) meet specifications of physical properties and/or functions of the coated bioactive granule (hereinafter referred to as “product specifications”), based on deviations between product data and product specifications, characterized in that it comprises a step of reducing the concentration of a volatile matters contained in the bioactive substance. The coated bioactive granule produced by the above method exhibits a significantly reduced change in the release function caused by the elapse of time during storage, and a product having predetermined properties and functions at the time of practical use can be obtained with stability even when production conditions are amended using product data obtained immediately after the production.

### TECHNICAL FIELD

The present invention relates to a method for producing a coated bioactive granule.

### BACKGROUND ART

In the agricultural environment of late years where the agricultural population decreases, and the agricultural workers become aged, it is demanded to realize labor saving and high efficiency in workings such as fertilization and spraying of bioactive substance including fertilizers and agricultural chemicals, and coated fertilizers in which a fertilizer granule as a core grain is coated with a resin or sulfur, and coated agricultural chemicals in which agricultural chemicals as a core grain are coated with a resin are developed. The technical contents thereof are already opened through patents and so on.

With respect to the coated fertilizers, for example, JP-A-63-162593 discloses a coated granular urea nitrate potassic fertilizer capable of properly supplying a fertilizer component with the absorption of crops; and JP-A-4-202079 discloses a double-layer coated granular fertilizer capable of controlling the period for the start of elution.

On the other hand, with respect to the coated agricultural chemicals, for example, JP-B-64-5002 discloses a coated granular agricultural chemical in which the release of an agricultural chemical component is sustained; and JP-A-6-9303 discloses a coated agricultural granule in which an agricultural granule is coated by a multilayered coating film composed of a layer of a swelling substance having high water absorption properties and a layer of an olefinic polymer.

These coated fertilizers and coated agricultural chemicals sustain the release of bioactive substances represented by fertilizers and agricultural chemicals and are an effective material for labor saving of agricultural works such as fertilization and agricultural chemical spraying.

Especially, in coated fertilizers having a sustained release function of a time-limited release type composed of a release-controlling period in which after the application, the release of a fertilizer is controlled for a certain period of time (hereinafter referred to as “d1”) and a release period in which after the elapse of a certain period, the release lasts (hereinafter referred to as “d2”), it became possible to apply a large amount of the fertilizer simultaneously with seeding or transplant of seedlings to a field by the sustained release function, so that the labor saving in the fertilization was further improved.

However, in these coated bioactive granules represented by coated fertilizers and coated agricultural chemicals, though the release-controlling function of each active substance was extremely effective, there was often found the case where a difference was generated between the release function immediately after the production (length of release period, release rate, etc.) and the release function after the long-term storage. That is, there was often found the case where in the release function after storage, a change by the elapse of time was caused. Such change by the elapse of time was influenced by storage conditions, and it was difficult to predict to what extent the change will occur. In addition, even when product data at the time of shipping meet the product specifications, there was often found the case where the product fell outside the predetermined physical properties and function during the use.

### DISCLOSURE OF THE INVENTION

In order to develop a coated bioactive granule that does not have a change in release function caused by the elapse of time after the storage, the present inventors made extensive and intensive investigations. As a result, it has been found that in a coated bioactive granule produced by a method for producing a coated bioactive granule in which the surfaces of core grains containing a bioactive substance are coated by a coating film, the method including a step of reducing the concentration of a volatile substance contained in the coated bioactive substance, a change in release function caused by the elapse of time during the storage is extremely small.

Further, the present inventors have found that in a method for producing a coated bioactive granule in which the production conditions are controlled on the basis of deviations between product data and product specifications in a manner such that the product data meet the product specifications, if the method includes a step of reducing the concentration of a volatile substance contained in the coated bioactive substance, even in the case where the production conditions are controlled by using the product data immediately after the production, predetermined physical properties and functions during the use are stably obtained. The present inventors have accomplished the invention on the basis of these findings.

The invention has the following configurations (1) to (14).

(1) A method for producing a coated bioactive granule in which the surfaces of core grains containing a bioactive substance are coated by a coating film, characterized by including a step of reducing the concentration of a volatile substance contained in the coated bioactive substance.

(2) The method for producing a coated bioactive granule as set forth in (1) above, wherein the step of reducing the concentration of a volatile substance contained in the coated bioactive substance is a step of reducing the concentration of the volatile substance contained in the coated bioactive substance to 500 ppm or less based on the coated bioactive substance.

(3) The method for producing a coated bioactive granule as set forth in (1) above, wherein the step of reducing the concentration of a volatile substance contained in the coated bioactive substance is a step of reducing the concentration of the volatile substance contained in the coated bioactive substance to 100 ppm or less based on the coated bioactive substance.

(4) The method for producing a coated bioactive granule as set forth in (1) above, wherein the step of reducing the concentration of a volatile substance contained in the coated bioactive substance is a step of reducing the concentration of the volatile substance contained in the coated bioactive substance to 10 ppm or less based on the coated bioactive substance.

(5) The method for producing a coated bioactive granule as set forth in (1) above, wherein the step of reducing the concentration of a volatile substance contained in the coated bioactive substance is a step of reducing the concentration of the volatile substance contained in the coated bioactive substance to 5 ppm or less based on the coated bioactive substance.

(6) The method for producing a coated bioactive granule as set forth in (1) above, wherein the step of reducing the concentration of a volatile substance contained in the coated bioactive substance is a step of reducing the concentration of the volatile substance contained in the coated bioactive substance to 1 ppm or less based on the coated bioactive substance.

(7) The method for producing a coated bioactive granule as set forth in (1) above, wherein the step of reducing the concentration of a volatile substance contained in the coated bioactive substance is a step of blowing hot air into the coated bioactive granule to reduce the concentration, including an operation of recovering the volatile substance contained in the hot air by activated carbon.

(8) The method for producing a coated bioactive granule as set forth in (1) above, wherein the step of reducing the concentration of a volatile substance contained in the coated bioactive substance is a step of blowing hot air into the coated bioactive granule to reduce the concentration, including an operation of primarily recovering the volatile substance contained in the hot air by a condenser and then secondarily recovering it by activated carbon.

(9) A method for producing a coated bioactive granule by controlling production conditions on the basis of deviations between physical properties and/or functions of the produced coated bioactive granule (hereinafter referred to as “product data”) and physical property specifications of the coated bioactive granule and/or function specifications of the coated bioactive granule (hereinafter referred to as “product specifications”) in a manner such that the product data meet the product specifications, characterized by including a step of reducing the concentration of a volatile substance contained in the coated bioactive substance.

(10) The method for producing a coated bioactive granule as set forth in (9) above, wherein the step of reducing the concentration of a volatile substance contained in the coated bioactive substance is a step of reducing the concentration of the volatile substance contained in the coated bioactive substance to 500 ppm or less based on the coated bioactive substance.

(11) The method for producing a coated bioactive granule as set forth in (9) above, wherein the step of reducing the concentration of a volatile substance contained in the coated bioactive substance is a step of reducing the concentration of the volatile substance contained in the coated bioactive substance to 100 ppm or less based on the coated bioactive substance.

(12) The method for producing a coated bioactive granule as set forth in (9) above, wherein the step of reducing the concentration of a volatile substance contained in the coated bioactive substance is a step of reducing the concentration of the volatile substance contained in the coated bioactive substance to 10 ppm or less based on the coated bioactive substance.

(13) The method for producing a coated bioactive granule as set forth in (9) above, wherein the step of reducing the concentration of a volatile substance contained in the coated bioactive substance is a step of reducing the concentration of the volatile substance contained in the coated bioactive substance to 5 ppm or less based on the coated bioactive substance.

(14) The method for producing a coated bioactive granule as set forth in (9) above, wherein the step of reducing the concentration of a volatile substance contained in the coated bioactive substance is a step of reducing the concentration of the volatile substance contained in the coated bioactive substance to 1 ppm or less based on the coated bioactive substance.

### BRIEF DESCRIPTION OF THE DRAWINGS

FIG. 1 is a cross-sectional view of a spouted bed coating device used in the production method of the invention, in which 1 is a spouting tower, 2 is a spray nozzle, 3 is a core grain, 4 is a hot air introduction piping, 5 is a coating film material introduction piping, and 6 is a guide piping.

FIG. 2 is a cross-section view of a degassing processing device used in the production method of the invention.

### BEST MODE FOR CARRYING OUT THE INVENTION

The invention will be described below in detail.

The coated bioactive granule as referred to in the invention means one in which the surfaces of core grains containing at least one bioactive substance are coated by a coating film.

The bioactive substance as referred to herein is used for the purposes of growing and protecting plants such as agricultural crops, useful plants, and agricultural products and brings about effects such as an increased yield, a high quality of agricultural crops, disease control, insect pest control, harmful animal control, and weed control, and additionally, growth promotion, growth retardation, and dwarfing of agricultural crops, depending upon the object for use. Concretely, it includes fertilizers, agricultural chemicals, and microorganisms. Especially, in the case where the bioactive substance is used for a coated bioactive granule, when it is a fertilizer or agricultural chemical, relatively high effects are obtained on the object for use.

As the fertilizer can be enumerated nitrogenous fertilizers, phosphatic fertilizers, and potassic fertilizers, as well as fertilizers containing potassium, magnesium, sulfur, iron, trace elements, silicon, etc. as essential elements of plant.

Concretely, examples of the nitrogenous fertilizers include ammonium sulfate, urea, ammonium nitrate, isobutyl aldehyde condensed urea, and acetaldehyde condensed urea; examples of the phosphatic fertilizers include calcium superphosphate, fused phosphate fertilizer, and calcined phosphate fertilizer; and examples of the potassic fertilizers include potassium sulfate, potassium chloride, and potassium silicate fertilizers. Their shape is not particularly limited. Further, highly complex fertilizers or mixed fertilizers having a total content of the three elements of the fertilizer of 30% or more, and organic fertilizers may also be used. Moreover, fertilizers to which a nitrification inhibitor or an agricultural chemical is added may be employed.

As the agricultural chemical can be enumerated disease controlling agents, insect pest controlling agents, harmful animal controlling agents, weed controlling agents, and plant growth regulators. These can be used without limitations regarding the kind thereof.

The disease controlling agent as referred to herein means a chemical to be used for the purpose of protecting agricultural crops, etc. from harmful actions of pathogenic microorganisms, and batericides are chiefly enumerated therefor. The inset pest controlling agents as referred to herein means a chemical to be used for controlling insects of agricultural crops, etc., and insecticides are chiefly enumerated therefor. The harmful animal controlling agent as referred to herein means a chemical for controlling plant parasitic mites, plant parasitic nematoda, rodents, birds, and other harmful animals, which infest agricultural crops, etc. The weed controlling agent as referred to herein means a chemical to be used for controlling plants and woods that will become harmful to agricultural crops, trees, etc. and is often called a herbicide. The plant growth regulator as referred to herein means a chemical to be used for the purpose of promotion or inhibition of physiological function of plant.

Though the agricultural chemical is desirably in a powdered state at ambient temperature, it may be a liquid at ambient temperature. Further, in the invention, the agricultural chemical may be soluble in water, sparingly soluble in water, or insoluble in water, and there are no particular limitations.

Specific examples of the agricultural chemical will be described hereunder, but it should be construed that these are given only for illustrative purposes and that the invention is never limited thereto. The agricultural chemical may be a single component or a composite component of two or more thereof.

Examples include 1-(6-chloro-3-pyridylmethyl)-N-nitroimidazolidin-2-ylideneamine, O,O-diethyl-S-2-(ethylthio)ethylphosphorodithioate, 1,3-bis(carbamoylthio)-2-(N,N-dimethylamino)propane hydrochloride, 2,3-dihydro-2,2-dimethyl-7-benzo[b]furanyl=N-dibutylaminothio-N-methylcarbamate, (2-isopropyl-4-methylpyrimidyl-6)-diethylthiophosphate, 5-dimethylamino-1,2,3-trithiane borate, O,O-dipropyl-O-4-methylthiophenyl phosphate, ethyl=N-[2,3-dihydro-2,2-dimethylbenzofuran-7-yloxycarbonyl(methyl)aminothio]-N-isopropyl-β-alaninate, 1-naphthyl-N-methylcarbamate, 2-isopropoxyphenyl-N-methylcarbamate, diisopropyl-1,3-dithiolan-2-ylidene malonate, 5-methyl-1,2,4-triazolo[3,4-b]benzothiazole, 1,2,5,6-tetrahydropyrrolo[3,2,1-ij]quinolin-4-one, 3-allyloxy-1,2-benzoisothiazole-1,1,-dioxide, a sodium salt, dimethylamine salt or ethyl ester of 2,4-dichlorophenoxyacetic acid, a sodium salt or ethyl or butyl ester of 2-methyl-4-chlorophenoxy acetic acid, a sodium salt or ethyl ester of 2-methyl-4-chlorophenoxybutyric acid, α-(2-naphthoxy)propionanilide, S-1-methyl-1-phenyl-ethyl=piperidine-1-carbothioate, S-(4-chlorobenzyl)-N,N-diethylthiocarbamate, 5-t-butyl-3-(2,4-dichloro-5-isopropoxyphenyl)-1,3,4-oxadiazolin-2-one, 2-[4-(2,4-dichlorobenzoyl)-1,3-dimethylpyrazol-5-yloxy]acetophenone, 4-(2,4-dichlorobenzoyl)-1,3-dimethyl-5-pyrazolyl-p-toluenesulfonate, 3-isopropyl-2,1,3-benzo-thiadiazinone-(4)-2,2-dioxide or its sodium salt, 2-chloro-4-ethylamino-6-isopropylamino-s-triazine, 2-methylthio-4-ethylamino-6-(1,2-dimethylpropylamino)-s-triazine, 2-methylthio-4,6-bis(ethylamino)-s-triazine, 2-methylthio-4,6-bis(isopropylamino)-s-triazine, 1-(α,α-dimethylbenzyl)-3-(p-tolyl) urea, methyl=α-(4,6-dimethoxypyrimidin-2-ylcarbamoylsulfamoyl)-o-toluate, 2-benzothiazol-2-yloxy-N-methylacetanilide, 1-(2-chloroimidazo[1,2-a]pyridin-3-ylsulfonyl)-3-(4,6-dimethoxypyrimidin-2-yl) urea, S-benzyl=1,2-dimethylpropyl(ethyl)thiocarbamate, and 2-chloro-N-(3-methoxy-2-thenyl)-2′,6′-dimethylacetanilide.

In addition, as the agricultural chemical can be enumerated substances to derive phytoalexin as a low-molecular weight antibacterial substance which a plant synthesizes after contact and accumulates therein.

As the microorganisms, ones having a propagation inhibiting effect of pathogenic microorganisms can be used. Specific examples include mold fungi such as the genus Trichoderma (e.g., Trichoderma lignorum, Trichoderma viride), the genus Gliocladium (e.g., Gliocladium virens), the genus Cephalosporium, the genus Coniothyrium, the genus Sporidesmium, and the genus Laetisaria; and bacteria and ray fungi such as the genus Agrobacterium (e.g., Agrobacterium radiobacter), the genus Bacillus (e.g., Bacillus subtilis), the genus Pseudomonas (e.g., Pseudomonas cepacia, Pseudomonas glumae, Pseudomonas gladioli, Pseudomonas fluorescens, Pseudomonas aureofaciens, Pseudomonas putida), the genus Xanthomonas, the genus Erwinia, the genus Arthrobacter, the genus Corynebacterium, the genus Enterobacter, the genus Azotobacter, the genus Flavobacterium, the genus Streptomyces (e.g., Streptomyces achromogenes, Streptomryces phaeopurpurascens, Streptomryces hygroscopicus, Streptomyces nitrospores, Streptomyces vinaceus), the genus Actinoplanes, the genus Alcaligenes, the genus Amorphosporangium, the genus Cellulomonas, the genus Micromonospora, the genus Pasteurella, the genus Hafnia, the genus Rhizobium, the genus Bradyrhizobium, the genus Serratia, and the genus Ralstonia (e.g., Ralstonia solanacearum).

Of these, antibacterial substance-producing bacteria can be preferably used. Concretely, bacteria of the genus Pseudomonas having high antibacterial substance productivity are corresponding thereto. Examples of strains producing an antibacterial substance include Pseudomonas cepacia producing antibiotic pyrrolnitrin (to Rhizoctonia solani of radish); Pseudomonas fluorescens producing antibiotics phenazinecarboxylic acid (to Galeumannomyces graminis of wheat), pyrrolnitrin, pyoluteorin (to Rhizoctonia solani of cotton and Pythium aphanidermatum of cucumber), cyanides (to Thielaviopsis basicola of tobacco), diacetylfluoroglucinol (to Galeumannomyces graminis of wheat), etc.; and fluorescent bacteria of the genus Pseudomonas (such as Pseudomonas putida and Pseudomonas fluorescens) producing iron chelate substances siderophore (pseudobactin) and fluorescent siderophore (pyoverdin) which do not make pathogenic bacteria use iron in a soil but can make it use only for plants.

As other microorganisms are enumerated Agrobaterium radiobacter producing Agrocin 84 of bacteriocin (against Agrobacterium vitis), fluorescent bacteria of the genus Pseudomonas (such as Pseudomonas putida and Pseudomonas fluorescens) as plant growth-promoting rhizobacteria (PGPR) producing growth-promoting substances such as plant hormones, and bacteria of the genus Bacillus.

In particular, CDU decomposing bacteria (such as the genus Pseudomonas, the genus Arthrobacter, the genus Corynebacterium, and the genus Agrobacterium) and strains of the genus Streptomyces (for example, FERM-P-10533 deposited before the Fermentation Research Institute, as disclosed in JP-B-5-26462) have a remarkable inhibition force against soil infectious pathogenic mold fungi and hence, are preferably used.

With respect to the composition of the core grain containing the bioactive substance, there are no particular limitations so far as it contains one or more bioactive substance. The bioactive substance may be granulated alone, or may be granulated using a carrier such as clay, kaolin, talc, bentonite, and calcium carbonate, or a binder such as polyvinyl alcohol, sodium carboxymethyl cellulose, and starch. Further, if desired, it may contain surfactants such as polyoxyethylene nonylphenyl ether, blackstrap molasses, animal oils, vegetable oils, hydrogenated oils, fatty acids, fatty acid metal salts, paraffins, waxes, glycerin, etc.

As the granulation method of the core grains can be employed extrusion granulation, fluidized bed type granulation, rolling granulation, compression granulation, coating granulation, and adsorption granulation. In the invention, though any of these granulation methods may be employed, the extrusion granulation is the simplest.

The adsorption granulation as referred to in the invention is a method in which the bioactive substance is adsorbed onto a granulation carrier by spraying, dropwise addition, or throwing. As the granulation carrier can be exemplified pumice, zeolite, bentonite, and perlite. In the adsorption of the bioactive substance onto the granulation carrier, in order to enhance the uniformity of the adsorption, it is effective to use a diluent. An amount of the bioactive substance to be adsorbed onto the granulation carrier can be regulated by adding white carbon, etc. to the granulation carrier to change the lipophilic property of the granulation carrier.

Although a grain size of the core grain is not particular limited, for example, in the case of the fertilizer, it is preferably from 1.0 to 10.0 mm, and in the case of the agricultural chemical, it is preferably from 0.3 to 3.0 mm. The arbitrary grain size falling within the above-described range can be selected by using a sieve.

A shape of the core grain is not particularly limited. But, in order to realize a sustained release function of a time-limited release type, a spherical granule is preferred. Concretely, a circularity coefficient as a measure for knowing a circularity of the core grain may be used. A value of the circularity coefficient as determined from the equation, {[4π×(projected area of core grain)]/(length of contour of projection of core grain)²} is preferably 0.7 or more, more preferably 0.75 or more, and most preferably 0.8 or more. A maximum value of the circularity coefficient is 1. As the circularity coefficient is closed to 1, the core grain becomes closed to a true circle, and as the core grain shape gets out of the true circle, the circularity coefficient becomes small.

For example, in a coated bioactive granule having a sustained release function of a time-limited release type composed of a release-restrating period in which after the application, the release of a bioactive substance is restrated for a certain period of time (hereinafter referred to as “d1”) and a release period in which after the elapse of a certain period, the release lasts (hereinafter referred to as “d2”) (the coated bioactive granule being hereinafter referred to as “time-limited release type coated bioactive granule”), when the number of the core grains having a circularity coefficient less than 0.7 increases, the release restraint in d1 of the coated bioactive granule having a sustained release function of a time-limited release type as obtained by using the foregoing core grains becomes insufficient so that the leakage of the bioactive substance is liable to occur. Accordingly, in the core grains to be used in the invention, it is preferred that all of the core grains have a circularity coefficient of 0.7 or more. But, so far as the effects of the invention are not largely deteriorated, a slight amount of core grains having a circularity coefficient less than the lower limit may be present. Incidentally, the above-described circularity coefficient can be measured by using a commercially available measurement instrument such as PIAS-IV (produced by Pias Co., Ltd.).

As the coating film of the coated bioactive granule can be enumerated ones containing a resin and those containing an inorganic substance such as sulfur.

In the coating film containing a resin, the content of the resin is preferably in the range of from 10 to 100% by weight, and more preferably from 20 to 100% by weight based on the weight of the coating film.

In the coating film containing an inorganic substance, the content of the inorganic substance is preferably in the range of from 20 to 100% by weight, and more preferably from 50 to 90% by weight based on the weight of the coating film.

The resin to be used for the coating film is not particularly limited, but there are enumerated thermoplastic resins, thermosetting resins, and emulsions.

Specific examples of the thermoplastic resins include olefinic polymers, vinylidene chloride-based polymers, diene-based polymers, waxes, polyesters, petroleum resins, natural resins, fats and oils and modified products thereof, and urethane resins.

Examples of the olefinic polymers include polyethylene, polypropylene, an ethylene-propylene copolymer, an ethylene-carbon monoxide copolymer, an ethylene-hexene copolymer, an ethylene-butadiene copolymer, polybutene, a butene-ethylene copolymer, a butene-propylene copolymer, polystyrene, an ethylene-vinyl acetate copolymer, an ethylene-vinyl acetate-carbon monoxide copolymer, an ethylene-acrylic acid copolymer, and an ethylene-methacrylic ester copolymer; and examples of the vinylidene chloride-based polymers include a vinylidene chloride-vinyl chloride copolymer.

Examples of the diene-based polymers include a butadiene polymer, an isoprene polymer, a chloroprene polymer, a butadiene-styrene copolymer, an EPDM polymer, and a styrene-isoprene copolymer.

Examples of the waxes include beeswax, Japan tallow, and paraffins; examples of polyesters include aliphatic polyesters such as polylactic acid and polycaprolactone and aromatic polyesters such as polyethylene terephthalate; examples of the natural resins include natural rubber and rosin; and examples of the oils and fats and modified products thereof include cured materials, solid fatty acids, and metal salts.

Examples of the thermosetting resins include phenol resins, furan resins, xylene-formaldehyde resins, ketone formaldehyde resins, amino resins, alkyd resins, unsaturated polyesters, epoxy resins, silicon resins, urethane resins, and drying oils.

With respect to these thermosetting resins, many monomer combinations are available. In the invention, there are no particular limitations regarding the kind and combination of monomers. Further, in addition to the polymers of monomers are employable dimers or polymers, and polymers of these mixtures.

Compounds of a plurality of resins having a different kind are employable.

As the phenol resins can be used ones obtained by condensation reaction of at least one member selected from phenols such as phenol, o-cresol, m-cresol, p-cresol, 2,4-xylenol, 2,3-xylenol, 3,5-xylenol, 2,5-xylenol, 2,6-xylenol, and 3,4-xylenol, and at least one member selected from aldehydes represented by formaldehyde.

As representative examples of the furan resins can be enumerated phenol-furfural resins, furfural-acetone resins, and furfuryl alcohol resins.

As the xylene-formaldehyde resins can be used ones obtained by condensation reaction of at least one member selected from xylenes such as o-xylene, m-xylene, p-xylene, and ethylbenzene, and at least one member selected from aldehydes represented by formaldehyde.

Examples of the ketone formaldehyde resins include acetone-formaldehyde resins, cyclohexanone-formaldehyde resins, acetophenone-formaldehyde resins, and higher aliphatic keton-formaldehyde resins.

As the amino resins can be enumerated ones obtained by condensation reaction of at least one member selected from amino group-containing monomers such as urea, melamine, thiourea, guanidine, dicyandiamide, guanamines, and aniline, and formaldehyde.

The alkyd resins may be any of a non-conversion type or a conversion type, and examples include ones obtained by condensation of at least one member selected from polyhydric alcohols such as glycerin, pentaerythritol, ethylene glycol, diethylene glycol, triethylene glycol, propylene glycol, sorbitol, mannitol, and trimethylolpropane, and polybasic acids such as phthalic anhydride, isophthalic acid, maleic acid, fumaric acid, sebacic acid, adipic acid, citric acid, tartaric acid, malic acid, diphenic acid, 1,8-naphthalic acid, and adducts of turpentine oil, rosin, an unsaturated fatty acid, and maleic acid.

Examples of fatty oils or fatty acids that are used during modification of the alkyd resin include linseed oil, soybean oil, perilla oil, fish oil, tung oil, sunflower oil, walnut oil, oiticica oil, caster oil, dehydrated caster oil, distilled fatty acids, cotton seed oil, coconut oil, and fatty acids thereof, and monoglycerides having been ester-exchanged with glycerin. Besides, resin modification products such as rosin, ester rosin, copal, and phenol resins can also be used.

As the unsaturated polyesters can be enumerated ones obtained by condensation reaction of at least one member selected from organic acids such as maleic anhydride, fumaric acid, itaconic acid, phthalic anhydride, isophthalic acid, terephthalic acid, tetrahydrophthalic anhydride, 3,6-endomethylenetetrahydrophthalic anhydride, adipic acid, sebacic acid, tetrachlorophthalic anhydride, and 3,6-endodichloromethylenetetrachlorophtalic acid, and at least one member selected from polyols such as ethylene glycol, diethylene glycol, 1,2-propylene glycol, dipropylene glycol, hydrogenated bisphenol A, 2,2-bis(4-oxyethoxyphenyl)propane, and 2,2-bis(4-oxypropoxyphenyl)propane.

Further, those obtained by addition of at least one member selected from vinyl monomers such as styrene, vinyltoluene, diallyl phthalate, methyl methacrylate, triallyl cyanurate, and triallyl phosphate for the purpose of promoting the curing of the unsaturated polyester during the condensation can be used.

Examples of the epoxy resins include epoxy resins of bisphenol A type, novolak type, bisphenol F type, tetrabisphenol A type, and diphenolic acid type.

In addition, composite resins such as urethanized polyester resins can be used.

As the urethane resins can be enumerated ones obtained by polyaddition polymerization of at least one member selected from diisocyanates such as tolylene diisocyanate, 3,3′-bi-tolylene-4,4′-diisocyanate, diphenylmethane-4,4′-diisocyanate, polymethylene polyphenylene polyisocyanate, 3,3′-dimethyl-diphenylmethane-4,4′-diisocyanate, m-phenylene diisocyanate, triphenylmethane triisocyanate, 2,4-tolylene diisocyanate, tolidine diisocyanate, hexamethylene diisocyanate, isophorone diisocyanate, xylene diisocyanate, dicyclohexylmethane diisocyanate, hydrogenated xylene diisocyanate, and naphthalene-1,5-diisocyanate, and at least one member selected from polyols such as polyoxypropylene polyol, polyoxyethylene polyol, acrylonitrile-propylene oxide polymers, styrene-propylene oxide polymers, polyoxytetramethylene glycol, adipic acid-ethylene glycol, adipic acid-butylene glycol, adipic acid-trimethylolpropane, glycerin, polycaprolactone diol, polycarbonate diol, polybutadiene polyol, and polyacrylate polyol.

In order to achieve the sustained release function over a long period of time and further the sustained release function of a time-limited release type, it is necessary to completely coat the surfaces of the core grains by a resin having low moisture permeability, thereby forming a coating film capable of suppressing permeation of the moisture at an extremely low level. Namely, it is important to form a coating film free from pinholes or cracks. In particular, in the sustained release function of a time-limited release type, in the case where a long d1 is required, it is effective to form a coating film having low moisture permeability on the surfaces of the core grains. By coating the surfaces of the core grains by the resin coating film having low moisture permeability, it is possible to gradually penetrate the moisture present outside into the core grains containing the bioactive substance taking a lot of time.

In order to achieve this, it is effective to coat the core grains by the coating film containing a thermoplastic resin. In addition, useful examples of the thermoplastic resin include olefin polymers, olefin copolymers, vinylidene chloride polymers, and vinylidene chloride copolymers. In particular, polyethylene, polypropylene, an ethylene-propylene copolymer, an ethylene-carbon monoxide copolymer, an ethylene-hexene copolymer, an ethylene-butene copolymer, a propylene-butene copolymer, and mixtures thereof can be enumerated as the most preferable coating film material. When a coating film free from pinholes or cracks is formed by using such a coating film material, the penetration amount of the moisture is extremely low.

Further, the coated bioactive granule may be one in which a filler or a surfactant for imparting hydrophilicity is added to the coating film. Examples of the filler include talc, clay, kaolin, bentonite, sulfur, muscovite, phlogopite, micaceous iron oxide, metal oxides, silicates, glass, carbonates or sulfates of alkaline earth metals, and starch. Examples of the surfactant include nonionic surfactants represented by fatty acid esters of polyols.

The volatile substance as referred to in the invention means a substance having a vapor pressure of 1×10⁻⁴ Pa or more at 25° C.

Examples of the volatile substance to be contained in the coated bioactive granule include the solvents (such as n-hexane), water, surfactants, unreacted monomers, and prepolymers having a low degree of polymerization, which are used during the polymerization of the resin, and the solvents that are used during the formation of the coating film.

The method for coating the surfaces of the core grains containing the bioactive substance by the coating film is not particularly limited. For example, there are enumerated a method for spraying a melt of the coating film material on the surfaces of the core grains; a method for spraying a coating film material solution of the coating film material dissolved in a solvent on the surfaces of the core grains; a method for attaching a powder of the coating film material to the surfaces of the core grains and then melting it; a method for spraying a monomer on the surfaces of the core grains and reacting it on the surfaces of the core grains to form a resin (a coating film); and a dipping method for dipping the core grains in a melt of the coating film material or a solution of the coating film material.

The coated bioactive granule can be produced by, for example, previously producing core grains comprising at least one bioactive substance and coating the surfaces of the core grains by the coating film.

As the method for coating the coating film material including a resin on the core grains can be enumerated a method in which a solution of the coating film material dissolved in a solvent capable of dissolving the resin in the coating film material is attached to the surfaces of the core grains by spraying to form the coating film (this method being hereinafter referred to as “solution spraying method”) and a method in which a melt of the coating film material obtained by heat melting the coating film material is attached to the surfaces of the core grains by spraying to form the coating film (this method being hereinafter referred to as “melt spraying method”).

The coated bioactive granule may be obtained in any of these methods. But, from the standpoint of high production efficiency or uniformity of the coating film obtained, a method in which the solution of the coating film material is attached to the core grains in the rolling or fluidized state, followed by exposing to hot air to form the coating film is preferred.

In the case where the filler is dispersed in the coating film containing the resin, in order to control the elution of the bioactive substance in a good state, it is important that the filler is uniformly dispersed within the coating film.

In the invention, the state where the filler is uniformly dispersed within the coating film means the case where a coefficient of variation as determined by the following method is 50% or less. In the invention, the coefficient of variation is preferably 35% or less.

The coefficient of variation is determined in the following manner. That is, in a cut surface of the coating film of the coated granule (one designated as “1” being eliminated), the thickness direction is defined as a longitudinal direction, and the parallel direction to the film surface is defined to be a transverse direction; with respect to 20 grains arbitrarily extracted, 10 portions having a range of 20 μm (longitudinal)×50 μm (transverse) as arbitrarily extracted from the cut surface of the coating film of the coated granule (one designated as “1” being eliminated) are observed by an electron microscope; the number of fillers present in each of the portions is measured, and the coefficient of variation=((standard deviation)/(mean value)×100) is determined from the results.

In order to obtain the film having a filler uniformly dispersed therein, it is preferred to produce the coated bioactive granule by the solution spraying method.

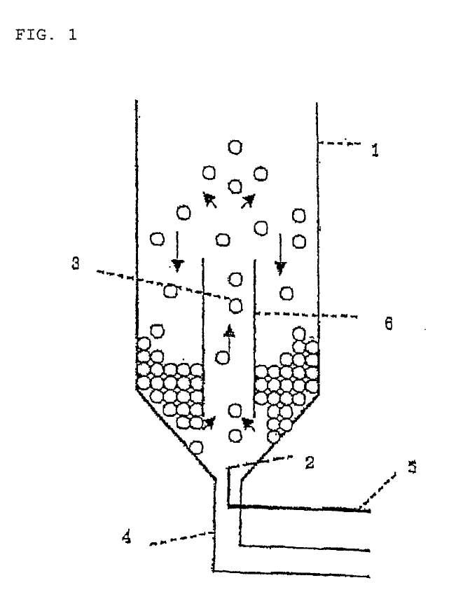

One example of coating devices that can be used for the solution spraying method is described with reference to a spouting device as shown in FIG. 1. In this method, in order to uniformly disperse the coating film material insoluble in the solvent, such as the inorganic filler, it is especially necessary to vigorously stir the coating film material solution.

In this spouting device, the coating film material solution is transported through a piping 5 and sprayed onto and blown into the surfaces of core grains 3 in a spouted state from a spray nozzle 2 to coat the surfaces, and simultaneously, a high-temperature gas is flown into a guide piping 6 from a lower section of a spouting tower 1, whereby the solvent in the coating film material solution attached to the surfaces of the core grains is instantly vaporized and dried by the high-speed hot air stream.

The spraying time varies depending upon the resin concentration of the coating film material solution and the spraying volume of the solution per certain period of time and coating rate and should be properly selected according to the object.

As the coating devices other than the spouting device as shown in FIG. 1, which can be used in the invention, examples of fluidized bed type or spouted bed type devices include the devices as disclosed in JP-B-42-24281 and JP-B-42-24282, in which a fountain type fluidized bed of core grains is formed by a gaseousness, and a coating agent is sprayed into a dispersion bed of core grains generated in the center thereof. Examples of rotary devices include the devices as disclosed in JP-A-7-31914 and JP-A-7-195007, in which powdered granules are carried upward by lifters provided in the inner periphery of a drum by means of rotation of the drum and then dropped, and during dropping, a coating agent is applied on the surfaces of the powdered granules to form a coating film.

In the case of obtaining the coated bioactive granule by the solution spraying method, the solvent to be used is not particularly limited. But, since the dissolution characteristic to each solvent is different depending upon the kind of the resin to be used for the coating film, the solvent may be selected according to the resin to be used.

As the solvent, in the case where olefin polymers, olefin copolymers, vinylidene chloride polymers, or vinylidene chloride copolymers are used as the resin, chlorine-based solvents and hydrocarbon-based solvents are preferred. Especially, tetrachloroethylene, trichloroethylen, and toluene are particularly preferred because a fine uniform coating film is obtained.

The step of reducing the concentration of the volatile substance contained in the coated bioactive granule as referred to in the invention means a degassing step for removing the volatile substance from the coated bioactive granule after the formation of the coating film on the surfaces of the core grains containing the bioactive substance.

The degassing method is not particularly limited, but examples include a method for heating the granule to extent such that the coating film is not damaged, by ventilation of hot air, irradiation of infrared rays, microwave, pressure reduction, pressure reduction with ventilation, etc.

In the invention, the degassing step is preferably carried out by ventilation of hot air. Concretely, the degassing step may be carried out by blowing a gas not containing the volatile substance, such as heated nitrogen or air, and water vapor, into the coated bioactive granule. In the case where water vapor is used, water vapor alone or a mixed gas with other gas may be used. In the case where water vapor is used, in order to avoid the moisture permeation into the core grains, it is preferred to dry the coated granule quickly after the degassing step.

In the coated bioactive granule, in the case where the formation of the coating film on the surfaces of the core grains is carried out several times, and a final product is then obtained, the degassing may be carried out after completion of the coating step, or the degassing may be carried out every time of the formation of the coating film. Further, the degassing may be carried out within the above-described coating device, or by a degassing device separately from the coating device.

In order to carry out the degassing of the volatile substance by a gas not containing the volatile substance or containing a trace amount of the volatile substance, the degassing may be carried out by obtaining a gas not substantially containing the volatile substance and quickly discharging the gas blown into the coated bioactive granule from a space for the degassing.

In the case where the gas after the degassing processing is circulated for reuse, it is preferred to purify the gas through separation of the volatile substance by activated carbon, etc. and then provide it for reuse. Further, a concentration of the volatile substance in the gas is preferably a dew point or lower.

In addition, the state of the coated bioactive granule during the degassing processing is not particularly limited but is preferably in a fluidized or rolling state.

At this time, the degassing temperature is not particularly limited. But, in the case where the coating film contains the thermoplastic resin, when a melting point of the thermoplastic resin contained in the coating film is defined to be T° C., it is preferably (T-60)° C. or higher and lower than (T-5)° C. In the case where the thermoplastic resin is single, the melting point of the resin is defined to be T° C., and in the case where the thermoplastic resin is in admixture of two or more, the melting point of the resin having a higher melting point is defined to be T° C. However, in the case where by the degassing processing under such temperature conditions, an inconvenience such as agglomeration among the coated bioactive granules occurs, it is preferred that the degassing is carried out at a temperature of the melting point of the resin having a lower melting point or lower. The melting point of a resin can be measured by using a known instrument for analysis such as DSC.

The degassing time varies depending upon the thickness of the coating film, the concentration of the volatile substance contained in the coated bioactive granule immediately after the production, and the like, but is preferably from 0.05 to 2 hours.

The volatile substance degassed from the coated bioactive granule immediately after completion of coating can be recovered through, for example, cooling or compression, or by using an adsorbing agent such as activated carbon. Accordingly, the recovery of the volatile substance enables to reuse the volatile substance in the coating step through recycle without being discharged as a waste, and hence, it can be said that the recovery is a preferable processing from the standpoints of environment and cost.

The recovery method of the volatile substance from the gas used for the degassing through ventilation of hot air is not particularly limited, but in the case where a large amount of the volatile substance is contained in the gas, a method for recovering the volatile substance using a condenser is preferred.

Further, in the case where the gas is circulated for reuse, since a recovery efficiency of the volatile substance from the coated bioactive granule is largely influenced by the concentration of the volatile substance contained in the recycled gas, it is preferred that the concentration is low as far as possible. As a method for reducing the concentration, a method for recovering the volatile substance using activated carbon is effective.

In addition, in the invention, the recovery of the volatile substance from the gas is preferably comprised of primary recovery by a condenser and secondary recovery by activated carbon.

The above-described degassing processing is particularly effective in the case where the coated bioactive granule is obtained by the solution spraying method. This is because in the solution spraying method, a large amount of the solvent is used during obtaining the coating film material solution, and therefore, the concentration of the volatile substance contained in the coated bioactive granule after completion of the coating step is liable to become very high.

A concentration of the volatile substance contained in the coated bioactive granule is preferably 500 ppm or less based on the coated bioactive granule. When the concentration of the volatile substance is 100 ppm or less, during the storage of the coated bioactive granule over a long period of time, a change of the release function by the elapse of time can be suppressed well. In the invention, the concentration of the volatile substance is more preferably 10 ppm or less, further preferably 5 ppm or less, and most preferably 1 ppm or less.

In the case where the coated bioactive granule having a sustained release function of a time-limited release type is produced, the concentration of the volatile substance is preferably 10 ppm or less, and more preferably 1 ppm or less.

The concentration of the volatile substance contained in the coated bioactive granule can be measured by, for example, extracting it with a solvent such as benzene and normal hexane, followed by a known analysis method such as gas chromatography (such as ECD).

Examples of the physical properties of the coated bioactive granule as referred to herein include a coating rate of the coating film to the coated bioactive granule, uniformity of the coating film, a strength of the coating film, water vapor permeability, and color. Examples of the function as referred to herein include a release rate, a release period, a release pattern, hydrophilicity (hydrophobicity) of the coating film surface, and decomposition properties of the coating film by light, oxygen or microorganisms.

The physical property specifications and the function specifications as referred to herein are specifications immediately after the production or after storage of the product in the above-described respective physical properties and functions and are expressed by specific numerical values or numerical values having a specific range.

The production conditions include production conditions during granulation of the core grains to be coated (hereinafter being referred to as “granulation conditions”) and production conditions during coating of the coating film on the surfaces of the core grains (hereinafter being referred to as “coating conditions”).

Basically, the granulation conditions include composition, temperature, water content, drying temperature, and drying time. Besides, in the extrusion granulation, the granulation conditions include pressure, die diameter, grain shape, feeding rate, and frictional force; in the fluidized bed type granulation, the granulation conditions include gas volume and charge amount; in the rolling granulation, the granulation conditions include mechanical strength of grains, shape retention, rolling rate, and feeding rate; in the compression granulation, the granulation conditions include pressure, compression time, grain size of raw material, plasticity of raw material, and kind and amount of binder; in the coating granulation, the granulation conditions include amount of coating liquid, the number of coating, shape of coating nozzle, and kind and amount of binder; and in the adsorption granulation, the granulation conditions include adsorption ability and oil absorption ability of carrier.

Basically, the coating conditions include composition of coating film, coating rate, drying temperature, and drying time. Besides, in the method in which the melt of the coating film material is sprayed on the surface of the bioactive granule, the coating conditions include melting temperature, spraying rate, and droplet diameter of spraying liquid; in the method in which the coating film material solution of the coating film material dissolved in a solvent is sprayed on the surface of the bioactive granule, the coating conditions include solution temperature, spraying rate, droplet diameter of spraying liquid, grain temperature, and amount of drying gas; in the method in which a powder of the coating film material is attached to the surface of the bioactive granule and then melted, the coating conditions include attachment amount, melting temperature, and melting time; in the method in which a monomer is sprayed on the surface of the bioactive granule and reacted on the surface of the granule to form a resin (a coating film), the coating conditions include spraying amount, reaction time, reaction temperature, and the number of spraying reactions; and in the dipping method in which the bioactive granule is dipped in a melt of the coating film material or a solution of the coating film material, the coating conditions include melt temperature and melt viscosity.

### EXAMPLES

The invention will be described with reference to the following Examples, but it should not be construed that the invention is limited to these Examples. In the following Examples, all “%” are “% by weight” unless otherwise indicated.

1. Production of Coated Bioactive Granule:

1) Production A of Coated Bioactive Granule (Production of Coated Granules 1 to 4):

Using a spouted bed coating device as shown in FIG. 1 (tower diameter: 450 mm, height: 4,000 mm, air exhaust nozzle diameter: 70 mm, cone angle: 50 degree), granular urea having a grain size of from 2.0 to 3.4 mm and a circularity coefficient of 0.8 as core grains containing the bioactive substance was coated by the coating film materials as shown in Table 1 until the coating rate became 12%, to produce coated bioactive granules 1 to 4. The production conditions were followed according to the following methods.

Further, the coating rate is a rate of a weight (A) of the coating film to the sum (100% by weight of the coated bioactive granule) of a weight (A) of the coated bioactive granule and the weight (B) of the coating film, which is a value determined by the equation, [B×100/(A+B)].

The coating film material solution is one prepared by uniformly dissolving and dispersing the coating film materials in the volatile substance in a proportion as shown in Table 1, in which the concentration of the coating materials to the coating film material solution was set to be 1.0% by weight.

Single-fluid nozzle: full-cone type having an outlet diameter of 0.8 mm

Granular fertilizer: 10 kg

Hot air temperature: 100 to 110° C.

Gas volume of hot air: 240 m³/hr

Spray flow rate: 0.5 kg/min

TABLE 1

| | Coating film material | | | | | | | | Vapor pressure of |
|---|---|---|---|---|---|---|---|---|---|
| | Coating film | | Coating film | | Coating film | | Coating film | | volatile substance |
| | material 1 | | material 2 | | material 3 | | material 4 | | (at 25° C.) |
| Coated bioactive | PE | 25 | EVA | 15 | Talc | 60 | SA | 0.5 | Tetrachloroethylene |
| granule 1 | | | | | | | | | (2,460 Pa) |
| Coated bioactive | ECO | 40 | Starch | 6 | Talc | 54 | — | — | Toluene |
| granule 2 | | | | | | | | | (3,793 Pa) |
| Coated bioactive | PE | 39 | PCL | 1 | Talc | 60 | — | — | Tetrachloroethylene |
| granule 3 | | | | | | | | | (2,460 Pa) |
| Coated bioactive | PP | 40 | Starch | 6 | Talc | 54 | — | — | Tetrachloroethylene |
| granule 4 | | | | | | | | | (2,460 Pa) |
| Coated bioactive | PLA | 50 | — | — | Talc | 50 | — | — | Trichloroethylene |
| granule 5 | | | | | | | | | (9,902 Pa) |
| Coated bioactive | PE | 32 | — | — | Talc | 68 | — | — | Tetrachloroethylene |
| granule 6 | | | | | | | | | (2,460 Pa) |
| Coated bioactive | PE | 60 | — | — | Sulfur | 40 | — | — | Tetrachloroethylene |
| granule 7 | | | | | | | | | (2,460 Pa) |

The numerals of the coating film materials mean parts by weight.

Vapor pressure: from Revised 5-th ed. Chemical Engineering Handbook, published by Maruzen Co., Ltd. (1988)

PE: Low-density polyethylene (MFR=23 g/10 min [JIS K6760], density: d=0.916 g/cm³, melting point: 105° C.)

EVA: Ethylene-vinyl acetate copolymer (MI=20, vinyl acetate: 30% by weight)

Talc: mean grain size: 5 μm

SA: Polyoxyethylene nonylphenyl ether (HLB=13)

ECO: Ethylene-carbon monoxide copolymer (MFR=0.75 g/10 min, CO=0.95% by weight, d=0.93 g/cm³, melting point: 120° C.)

PP: Polypropylene (MFR=3 g/10 min [JIS K6758], density: d=0.90 g/cm³, Vicat softening point: 145° C. [JIS K6758])

Starch: Maize starch (produced by Wako Pure Chemical Industries, Ltd.)

PCL: Poly-ε-caprolactone (Mn=80,000, melting point: 60° C.)

PLA: Poly-L-lactic acid (Mn=60,000)

Sulfur: Reagent

2) Production B of Coated Bioactive Granule (Production of Coated Granules 5 to 7):

Using a spouted bed coating device as shown in FIG. 1 (tower diameter: 250 mm, height: 2,000 mm, air exhaust nozzle diameter: 50 mm, cone angle: 50 degree), a granular agricultural chemical having a grain size of from 1.4 to 1.7 mm and a circularity coefficient of 0.8 as core grains containing the bioactive substance (bentonite: 60 parts by weight, clay: 25 parts by weight, Sankyo Diazinon Wettable Powder 34 (Diazinon 34%, produced by Kyushu Sankyo Co., Ltd.): 15 parts by weight) was coated by the coating film materials as shown in Table 1 until the coating rate became 20%, to produce coated bioactive granules 5 to 7. The production conditions were followed according to the following methods.

Further, the coating rate is a rate of a weight (b) of the coating film to the sum (100% by weight of the coated bioactive granule) of a weight (a) of the coated bioactive granule and the weight (b) of the coating film, which is a value determined by the equation, [b×100/(a+b)].

The coating film material solution is one prepared by uniformly dissolving and dispersing the coating film materials in the volatile substance in a proportion as shown in Table 1, in which the concentration of the coating materials to the coating film material solution was set to be 1.0% by weight.

Single-fluid nozzle: Full-cone type having an outlet diameter of 0.4 mm

Granular fertilizer: 3 kg

Hot air temperature: 100 to 110° C.

Gas volume of hot air: 70 m³/hr

Spray flow rate: 0.2 kg/min

2. Degassing of Volatile Substance:

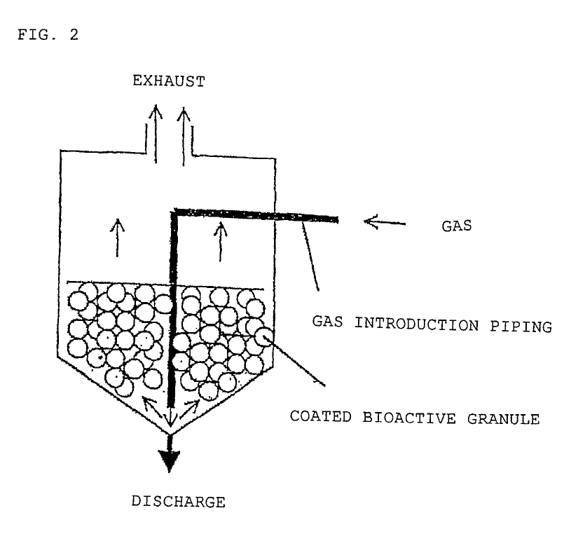

Using the coated granules 1 to 7 obtained in the productions A and B of coated bioactive granule, degassing processing of the volatile substance was carried out. Air having a concentration of volatile substance (such as trichloroethylene, perchloroethylene, and toluene) of less than 1 ppm was used as a gas to be tested. The temperature of the gas during the degassing processing was shown in Table 2. Using 500 g of each of the obtained coated bioactive granules 1 to 7, the degassing processing was carried out by a degassing device as shown in FIG. 2. After the production of the coated granules 1 to 7, each coated bioactive granule was charged into the degassing device as shown in FIG. 2, air was introduced into the device through a hot air introduction piping, and ventilation was carried out for 30 minutes to undergo the degassing processing. An exhaust gas is continuously discharged from an opening in the upper section, and after processing by a solvent recovery device, is reused as a gas for the degassing processing. By this degassing processing, Examples 1 to 7 were obtained. On the other hand, coated bioactive granules 1 to 7 to which no degassing processing had been subjected were made for Comparative Examples 1 to 7.

TABLE 2

| | | | Concentration |
|---|---|---|---|
| | | Presence of | of volatile |
| | | degassing processing | substance in |
| | | after coating | coated |
| | | (Gas | bioactive |
| | Tested core grain | temperature) | granule (ppm) |
| Example 1 | Coated bioactive | Yes (65° C.) | 5 |
| | granule 1 | | |
| Example 2 | Coated bioactive | Yes (70° C.) | 3 |
| | granule 2 | | |
| Example 3 | Coated bioactive | Yes (70° C.) | 2 |
| | granule 3 | | |
| Example 4 | Coated bioactive | Yes (70° C.) | 8 |
| | granule 4 | | |
| Example 5 | Coated bioactive | Yes (68° C.) | 23 |
| | granule 5 | | |
| Example 6 | Coated bioactive | Yes (50° C.) | 355 |
| | granule 6 | | |
| Example 7 | Coated bioactive | Yes (75° C.) | 8 |
| | granule 7 | | |
| Comparative | Coated bioactive | No | 3000 |
| Example 1 | granule 1 | | |
| Comparative | Coated bioactive | No | 4500 |
| Example 2 | granule 2 | | |
| Comparative | Coated bioactive | No | 3600 |
| Example 3 | granule 3 | | |
| Comparative | Coated bioactive | No | 4200 |
| Example 4 | granule 4 | | |
| Comparative | Coated bioactive | No | 5500 |
| Example 5 | granule 5 | | |
| Comparative | Coated bioactive | No | 5200 |
| Example 6 | granule 6 | | |
| Comparative | Coated bioactive | No | 6700 |
| Example 7 | granule 7 | | |

3. Measurement of Concentration of Volatile Substance:

With respect to Examples 1 to 7 and Comparative Examples 1 to 7, the concentration of the volatile substance was measured. With respect to Comparative Examples 1 to 7, the measurement of the concentration of the volatile substance was carried out immediately after the production (immediately after completion of the coating step), and with respect to Examples 1 to 7, it was carried out after the degassing processing of the volatile substance.

In the case where the volatile substance to be extracted was tetrachloroethylene or trichloroethylene, benzene was used as an extraction solvent, and in the case where the volatile substance to be extracted was toluene, normal hexane was used as the extraction solvent. 0.5 g of each of Examples 1 to 7 and Comparative Examples 1 to 7 was dipped in 50 mL of the extraction solvent at room temperature for one week, thereby extracting the volatile substance to prepare a sample for analysis.

For the sample for analysis, the volatile substance was analyzed by gas chromatography (detector: ECD (extraction solvent: benzene), FID (extraction solvent: normal hexane)) to determine the concentration of the volatile substance. The results were shown in Table 2.

4. Performance Evaluation Test:

The performance evaluation test was carried out by the following methods A and B. Comparative Examples 1 to 7 were tested immediately after the production (immediately after completion of the coating step), and Examples 1 to 7 were tested after the degassing processing. Separately, 100 g of each of Examples 1 to 7 and Comparative Examples 1 to 7 was charged respectively in a polyethylene bag having a thickness of 0.063 mm (trade name: REED as a refrigeration bag, produced by Lion Corporation) and sealed. After storing in a cold and dark place for 2 weeks, the performance evaluation test was carried out in the same manner as described above.

1) Performance Evaluation Test A:

10 g of each of Examples 1 to 4 and Comparative Examples 1 to 4 was dipped in 200 mL of water and allowed to stand at 25° C. After the elapse of time for a predetermined period, the coated bioactive granule was separated from water, and urea eluted into water was subjected to quantitative analysis. To the fertilizer was added 200 mL of fresh water, followed by standing at 25° C. After the elapse of time for a predetermined period, the same operation was carried out. These operations were repeated, and a relation between the accumulated total of elution of urea eluted into water and the number of days was graphed to prepare an elution rate curve. From the graph was read the number of days (d1) when the accumulated total of elution reached 10%. The results were shown in Table 3.

2) Performance Evaluation Test B:

In the test was measured a time until 10% of the agricultural chemical contained the core grains within the test sample was released outside by the formation of cracks in the coating film of the test sample to cause breakage of the coating film.

In a cap-equipped test tube (12 mm×72 mm) having 1.5 mL of water charged therein was charged each of Examples 5 to 7 and Comparative Examples 5 to 7 at a rate of one grain per test tube, followed by capping. Using 100 test tubes (grains) of each of Examples 5 to 7 and Comparative Examples 5 to 7, the number of collapsed grains in the respective coated bioactive granules was counted under a condition of constant water temperature of 20° C. The observation was carried out every day from the start of the test. A relation between the accumulated total of release and the number of days was graphed from the obtained results, to prepare a release rate curve. From the graph was read the number of days (d1) when the accumulated total of elution reached 10%. The results were shown in Table 3.

TABLE 3

| | Performance evaluation test | |
|---|---|---|
| | Immediately after | After the elapse of two weeks |
| | the production | after the production |
| | d1 (days) | d1 (days) |
| Example 1 | 8 | 9 |
| Example 2 | 40 | 39 |
| Example 3 | 199 | 203 |
| Example 4 | 52 | 52 |
| Example 5 | 10 | 10 |
| Example 6 | 30 | 32 |
| Example 7 | 98 | 95 |
| Comparative | 4 | 7 |
| Example 1 | | |
| Comparative | 22 | 31 |
| Example 2 | | |
| Comparative | 133 | 160 |
| Example 3 | | |
| Comparative | 30 | 41 |
| Example 4 | | |
| Comparative | 3 | 6 |
| Example 5 | | |
| Comparative | 4 | 13 |
| Example 6 | | |
| Comparative | 30 | 65 |
| Example 7 | | |

d1: The number of days required for 10% elution

As is clear from Table 3, in Examples 1 to 7, the change by the elapse of time was very slight in the release function after the storage for 2 weeks, whereas in Comparative Examples 1 to 7, the change by the elapse of time was markedly observed.

In the following Examples, coated granular urea fertilizers of a time-limited release type falling within the scope of the invention, in which the release function as expected during the use is d1=40±3 days (at 25° C. in water, hereinafter referred to as “D1”) and d2=60±6 days (at 25° C. in water, hereinafter referred to as “D2”), are produced. According to the product specifications immediately after the production of the coated granular urea fertilizer, d1 as a value measured by the following release function measurement method 1 is 19±1 days.

5. Production of Coated Granular Urea Fertilizer:

Production Method 1:

1) Coating Step:

Using a spouted bed coating device as shown in FIG. 1, granular urea having a grain size of from 2.0 to 3.4 mm and a circularity coefficient of 0.8 as core grains containing the bioactive substance was coated by the following coating film composition until the coating rate became 12%. The production conditions were followed according to the following methods.

Further, the coating rate is a rate of a weight (A) of the coating film to the sum (100% by weight of the coated granular urea fertilizer) of a weight (A) of the granular urea and the weight (B) of the coating film, which is a value determined by the equation, [B×100/(A+B)].

The coating film material solution is one prepared by uniformly dissolving and dispersing the coating film materials in the volatile substance in a proportion as shown in Table 1, in which the concentration of the coating materials to the coating film material solution was set to be 1.0% by weight.

Single-fluid nozzle: Full-cone type having an outlet diameter of 0.8 mm

Solution temperature of coating material: 100 to 110° C.

Temperature of coating material solution: 80 to 110° C.

Granular fertilizer: 10 kg

Hot air temperature: 100 to 110° C.

Gas volume of hot air: 240 m³/hr

Spray flow rate: 0.5 kg/min

Coating film composition: ECO^{*1}/starch^{*2}/talc^{*3}=40/6/54 (the numerals being part by weight)

Volatile substance to be used: Tetrachloroethylene (vapor pressure^{*4} [25° C.]=2,460 Pa)

*1: Ethylene-carbon monoxide copolymer (MFR=0.75 g/10 min, CO=0.95% by weight, d=0.93 g/cm³, melting point: 120° C.)

*2: Maize starch (produced by Wako Pure Chemical Industries, Ltd.)

*3: Mean grain size: 5 μm

*4: from Revised 5-th ed. Chemical Engineering Handbook, published by Maruzen Co., Ltd. (1988)

2) Degassing Step of Volatile Substance:

Air having a concentration of volatile substance (such as trichloroethylene, perchloroethylene, and toluene) of less than 1 ppm was used as a gas to be tested. The temperature of the gas during the degassing processing was shown in Table 1. Using 500 g of the coated granular urea fertilizer obtained in the coating step of 1), the degassing processing was carried out by a degassing device as shown in FIG. 2.

Concretely, the coated granular urea fertilizer was charged into the degassing device as shown in FIG. 2, air at 50° C. was introduced into the device through a hot air introduction piping, and ventilation was carried out for 30 minutes to undergo the degassing processing. An exhaust gas is continuously discharged from an opening in the upper section, and after processing by a solvent recovery device, is reused as a gas for the degassing processing.

Production Method 2:

A coated granular urea fertilizer was produced in the same manner as in Production Method 1, except that the hot air temperature in the degassing step of volatile substance of 2) was changed to 60° C.

Production Method 3:

A coated granular urea fertilizer was produced in the same manner as in Production Method 1, except that the hot air temperature in the degassing step of volatile substance of 2) was changed to 70° C.

Production Method 4:

A coated granular urea fertilizer was produced in the same manner as in Production Method 1, except that the hot air temperature in the degassing step of volatile substance of 2) was changed to 80° C.

Production Method 5:

A coated granular urea fertilizer was produced in the same manner as in Production Method 1, except that the hot air temperature in the degassing step of volatile substance of 2) was changed to 85° C.

Production Method 6:

A coated granular urea fertilizer was produced in the same manner as in Production Method 1, except that the degassing step of volatile substance of 2) was omitted.

### Example 8

With respect to the coated granular urea fertilizer produced in Production Method 1, d1 before revision was measured by the release function measurement method 1 as described later, and the concentration of the volatile substance contained in the coated granular urea fertilizer was measured in the following method. The results were shown in Table 4. Since there was found a deviation of 3 days between the data of d1 before revision and the lower limit of the product specifications, the coating film composition of Production Method 1 was revised from ECO^{*1}/starch^{*2}/talc^{*3}=40/6/54 to ECO^{*1}/starch^{*2}/talc^{*3}=40.3/5.7/54.0, to again produce a coated granular urea fertilizer. The obtained coated granular urea fertilizer was provided for the storage test as described below, and d1 after revision was measured by the release function measurement method 1. The results were shown in Table 4.

### Example 9

With respect to the coated granular urea fertilizer produced in Production Method 2, d1 before revision was measured by the release function measurement method 1 as described later, and the concentration of the volatile substance contained in the coated granular urea fertilizer was measured in the following method. The results were shown in Table 4. Since there was found a deviation of 3 days between the data of d1 before revision and the lower limit of the product specifications, the coating film composition of Production Method 2 was revised from ECO^{*1}/starch^{*2}/talc^{*3}=40/6/54 to ECO^{*1}/starch^{*2}/talc^{*3}=40.3/5.7/54.0, to again produce a coated granular urea fertilizer. The obtained coated granular urea fertilizer was provided for the storage test as described below, and d1 after revision was measured by the release function measurement method 1. The results were shown in Table 4.

### Example 10

With respect to the coated granular urea fertilizer produced in Production Method 3, d1 before revision was measured by the release function measurement method 1 as described later, and the concentration of the volatile substance contained in the coated granular urea fertilizer was measured in the following method. The results were shown in Table 4. Since there was found a deviation of 2 days between the data of d1 before revision and the lower limit of the product specifications, the coating film composition of Production Method 3 was revised from ECO^{*1}/starch^{*2}/talc^{*3}=40/6/54 to ECO^{*1}/starch^{*2}/talc^{*3}=40.2/5.8/54.0, to again produce a coated granular urea fertilizer. The obtained coated granular urea fertilizer was provided for the storage test as described below, and d1 after revision was measured by the release function measurement method 1. The results were shown in Table 4.

### Example 11

With respect to the coated granular urea fertilizer produced in Production Method 4, d1 before revision was measured by the release function measurement method 1 as described later, and the concentration of the volatile substance contained in the coated granular urea fertilizer was measured in the following method. The results were shown in Table 4. Since there was found a deviation of 2 days between the data of d1 before revision and the lower limit of the product specifications, the coating film composition of Production Method 4 was revised from ECO^{*1}/starch^{*2}/talc^{*3}=40/6/54 to ECO^{*1}/starch^{*2}/talc^{*3}=40.2/5.8/54.0, to again produce a coated granular urea fertilizer. The obtained coated granular urea fertilizer was provided for the storage test as described below, and d1 after revision was measured by the release function measurement method 1. The results were shown in Table 4.

### Example 12

With respect to the coated granular urea fertilizer produced in Production Method 5, d1 before revision was measured by the release function measurement method 1 as described later, and the concentration of the volatile substance contained in the coated granular urea fertilizer was measured in the following method. The results were shown in Table 4. Since there was found a deviation of one day between the data of d1 before revision and the lower limit of the product specifications, the coating film composition of Production Method 5 was revised from ECO^{*1}/starch^{*2}/talc^{*3}=40/6/54 to ECO^{*1}/starch^{*2}/talc^{*3}=40.1/5.9/54.0, to again produce a coated granular urea fertilizer. The obtained coated granular urea fertilizer was provided for the storage test as described below, and d1 after revision was measured by the release function measurement method 1. The results were shown in Table 4.

### Comparative Example 8

With respect to the coated granular urea fertilizer produced in Production Method 6, d1 before revision was measured by the release function measurement method 1 as described later, and the concentration of the volatile substance contained in the coated granular urea fertilizer was measured in the following method. The results were shown in Table 4. Since there was found a deviation of 4 days between the data of d1 before revision and the lower limit of the product specifications, the coating film composition of Production Method 6 was revised from ECO^{*1}/starch^{*2}/talc^{*3}=40/6/54 to ECO^{*1}/starch^{*2}/talc^{*3}=40.4/5.6/54.0, to again produce a coated granular urea fertilizer. The obtained coated granular urea fertilizer was provided for the storage test as described below, and d1 after revision was measured by the release function measurement method 1. The results were shown in Table 4.

TABLE 4

| | Concentration | | | | |
|---|---|---|---|---|---|
| | of volatile | d1 | d1 | d1 after storage | d2 after storage |
| | substance | before | after | (Difference | (Difference |
| | (ppm) | revision | revision | from D1) | from D2) |
| Example 8 | 450 | 15 | 19 | 43 | 66 |
| | | | | (3) | (6) |
| Example 9 | 94 | 15 | 18 | 43 | 62 |
| | | | | (2) | (2) |
| Example 10 | 8 | 16 | 19 | 39 | 63 |
| | | | | (1) | (3) |
| Example 11 | 4 | 16 | 19 | 41 | 59 |
| | | | | (1) | (1) |
| Example 12 | 0.9 | 17 | 18 | 40 | 59 |
| | | | | (0) | (1) |
| Comparative | 1500 | 14 | 19 | 49 | 80 |
| Example 8 | | | | (9) | (20) |

Release Function Measurement Method 1:

10 g of the coated granular urea fertilizer was dipped in 200 mL of water and allowed to stand at 35° C. After the elapse of time for a predetermined period, the coated granular urea fertilizer was separated from water, and urea eluted into water was subjected to quantitative analysis. To the coated granular urea fertilizer was added 200 mL of fresh water, followed by standing at 35° C. After the elapse of time for a predetermined period, the same operation was carried out. These operations were repeated, and a relation between the accumulated total of elution of urea eluted into water and the number of days was graphed to prepare an elution rate curve. From the graph was read the number of days (d1 before revision and d1 after revision) when the accumulated total of elution reached 10%.

Measurement Method of Volatile Substance:

Using benzene as the extraction solvent, 0.5 g of the coated granular urea fertilizer was dipped in 50 mL of the extraction solvent at room temperature for one week, thereby extracting the volatile substance to prepare a sample for analysis.

For the sample for analysis, the volatile substance was analyzed by gas chromatography (detector: ECD (extraction solvent: benzene), FID (extraction solvent: normal hexane)) to determine the concentration of the volatile substance. The results were shown in Table 4.

Storage Test:

100 g of the coated granular urea fertilizer was charged in a polyethylene bag having a thickness of 0.063 mm (trade name: REED as a refrigeration bag, produced by Lion Corporation) and sealed. After storing in a cold and dark place for 3 months, d1 after storage was measured by the following release function measurement method 2. The measurement results were shown in Table 4.

Release Function Measurement Method 2:

10 g of the coated granular urea fertilizer was dipped in 200 mL of water and allowed to stand at 25° C. After the elapse of time for a predetermined period, the coated granular urea fertilizer was separated from water, and urea eluted into water was subjected to quantitative analysis. To the coated granular urea fertilizer was added 200 mL of fresh water, followed by standing at 25° C. After the elapse of time for a predetermined period, the same operation was carried out. These operations were repeated, and a relation between the accumulated total of elution of urea eluted into water and the number of days was graphed to prepare an elution rate curve. From the graph were read the number of days (d1 after storage) when the accumulated total of elution reached 10% and the number of days (d2 after storage) when the accumulated total of elution reached 90% after it had reached 10%, respectively. The measurement results were shown in Table 4.

### Industrial Applicability

In a coated bioactive granule produced by a method of the invention, a change in release function caused by the elapse of time during the storage is extremely small. Further, even in the case where the production conditions are revised by using the product data immediately after the production, predetermined physical properties and functions during the use can be stably obtained.

1. A method for producing a coated bioactive granule in which the surfaces of core grains containing a bioactive substance are coated by a coating film, characterized by including a step of reducing the concentration of a volatile substance contained in the coated bioactive substance.

2. The method for producing a coated bioactive granule according to claim 1, wherein the step of reducing the concentration of a volatile substance contained in the coated bioactive substance is a step of reducing the concentration of the volatile substance contained in the coated bioactive substance to 500 ppm or less based on the coated bioactive substance.

3. The method for producing a coated bioactive granule according to claim 1, wherein the step of reducing the concentration of a volatile substance contained in the coated bioactive substance is a step of reducing the concentration of the volatile substance contained in the coated bioactive substance to 100 ppm or less based on the coated bioactive substance.

4. The method for producing a coated bioactive granule according to claim 1, wherein the step of reducing the concentration of a volatile substance contained in the coated bioactive substance is a step of reducing the concentration of the volatile substance contained in the coated bioactive substance to 10 ppm or less based on the coated bioactive substance.

5. The method for producing a coated bioactive granule according to claim 1, wherein the step of reducing the concentration of a volatile substance contained in the coated bioactive substance is a step of reducing the concentration of the volatile substance contained in the coated bioactive substance to 5 ppm or less based on the coated bioactive substance.

6. The method for producing a coated bioactive granule according to claim 1, wherein the step of reducing the concentration of a volatile substance contained in the coated bioactive substance is a step of reducing the concentration of the volatile substance contained in the coated bioactive substance to 1 ppm or less based on the coated bioactive substance.

7. The method for producing a coated bioactive granule according to claim 1, wherein the step of reducing the concentration of a volatile substance contained in the coated bioactive substance is a step of blowing hot air into the coated bioactive granule to reduce the concentration, including an operation of recovering the volatile substance contained in the hot air by activated carbon.

8. The method for producing a coated bioactive granule according to claim 1, wherein the step of reducing the concentration of a volatile substance contained in the coated bioactive substance is a step of blowing hot air into the coated bioactive granule to reduce the concentration, including an operation of primarily recovering the volatile substance contained in the hot air by a condenser and then secondarily recovering it by activated carbon.

9. A method for producing a coated bioactive granule by controlling production conditions on the basis of deviations between physical properties and/or functions of the produced coated bioactive granule (hereinafter referred to as “product data”) and physical property specifications of the coated bioactive granule and/or function specifications of the coated bioactive granule (hereinafter referred to as “product specifications”) in a manner such that the product data meet the product specifications, characterized by including a step of reducing the concentration of a volatile substance contained in the coated bioactive substance.

10. The method for producing a coated bioactive granule according to claim 9, wherein the step of reducing the concentration of a volatile substance contained in the coated bioactive substance is a step of reducing the concentration of the volatile substance contained in the coated bioactive substance to 500 ppm or less based on the coated bioactive substance.

11. The method for producing a coated bioactive granule according to claim 9, wherein the step of reducing the concentration of a volatile substance contained in the coated bioactive substance is a step of reducing the concentration of the volatile substance contained in the coated bioactive substance to 100 ppm or less based on the coated bioactive substance.

12. The method for producing a coated bioactive granule according to claim 9, wherein the step of reducing the concentration of a volatile substance contained in the coated bioactive substance is a step of reducing the concentration of the volatile substance contained in the coated bioactive substance to 10 ppm or less based on the coated bioactive substance.

13. The method for producing a coated bioactive granule according to claim 9, wherein the step of reducing the concentration of a volatile substance contained in the coated bioactive substance is a step of reducing the concentration of the volatile substance contained in the coated bioactive substance to 5 ppm or less based on the coated bioactive substance.

14. The method for producing a coated bioactive granule according to claim 9, wherein the step of reducing the concentration of a volatile substance contained in the coated bioactive substance is a step of reducing the concentration of the volatile substance contained in the coated bioactive substance to 1 ppm or less based on the coated bioactive substance.
